(19) United States
(12) Patent Application Publication
(10) Pub. No.: US 2024/0134432 A1
(43) Pub. Date: Apr. 25, 2024

(54) CUSTOMIZED PER-APPLICATION POWER CONFIGURATION AND THERMAL CONFIGURATION ON INFORMATION SYSTEMS PLATFORM

(71) Applicant: Intel Corporation, Santa Clara, CA (US)

(72) Inventors: Akhilesh S. THYAGATURU, Ruskin, FL (US); Francesc GUIM BERNAT, Barcelona (ES); Karthik KUMAR, Chandler, AZ (US); Jonathan KYLE, Atlanta, GA (US); Marek PIOTROWSKI, Pepowo (PL)

(21) Appl. No.: 18/537,697

(22) Filed: Dec. 12, 2023

(51) Int. Cl. G06F 1/20; G06F 9/455

(52) U.S. Cl. CPC G06F 1/206; G06F 9/45558; G06F 2009/45591

(57) ABSTRACT

A method is claimed. The method includes receiving information associated with a software application's workflow. The method includes receiving information that describes a platform's current power consumption state and current thermal state. The method includes selecting platform components to support execution of the workflow. The method includes prior to execution of the workflow upon the selected platform components, estimating a thermal impact to the platform's current thermal state as a consequence of the workflow's execution upon the selected platform components. The method includes determining a change to be made to a thermal cooling system of the platform in response to the estimating and causing the change to be made to the thermal cooling system prior to execution of at least a portion of the workflow on the platform.

### BACKGROUND

With the increasing demand for information services and the corresponding increase in power consumption and heat dissipation by the underlying systems and components that perform the services, engineers are seeking ways to improve the cooling of these systems and components.

### BRIEF DESCRIPTION OF FIGURES

FIG. 1 shows an exemplary data center;

FIG. 2 shows power and thermal control within a data center;

FIG. 3 shows an improved data center power and thermal control system;

FIG. 4 shows an embodiment of an orchestrator;

FIG. 5 shows an method for assigning/allocating specific platform resources to support execution of an application;

FIG. 6 shows an emerging data center architecture;

FIGS. 7a and 7b depict an IPU.

### DETAILED DESCRIPTION

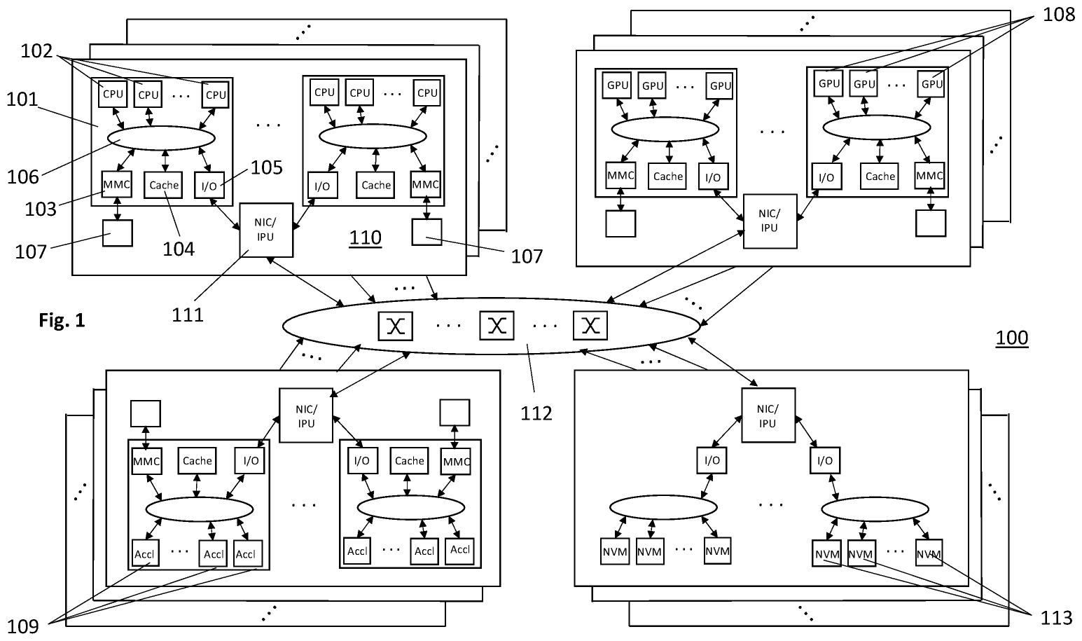

FIG. 1 depicts an exemplary information systems platform 100 such as a data center information system platform. As observed in FIG. 1, the platform includes multiple high performance semiconductor chips 101. The high performance semiconductor chips include multiple processing cores 102, a memory controller 103, a cache 104 and an I/O hub 105 (for ease of illustration chip 101 is fully labeled). The cores 102, memory controller 103, cache 104 and I/O hub 105 are communicatively coupled to one another on the semiconductor chip 101 with an internal network 106.

The functionality of the processing cores of a high performance semiconductor chip typically describes or defines the chip's type. For example, if the processing cores are mainly general purpose processor cores 102, the chip 101 is typically referred to as central processing unit (CPU) chip. By contrast, if the processing cores 108 are mainly graphic processors, the chip is typically referred to as graphics processing unit (GPU) chip. Further still, if the processing cores 109 are mainly dedicated hardwired application specific integrated circuit blocks (ASIC blocks) that are designed to perform a limited number of computationally intensive functions (e.g., compression/decompression, encryption/decryption, artificial intelligence machine learning or inferencing), the chip is typically referred to as an accelerator chip.

Different groups of the chips are integrated onto a printed circuit board and/or within a system chassis (such as a rack mountable unit), hereinafter referred to as a “system” 110 (for illustrative ease only system 110 is labeled). A system 110 typically includes one or more memory modules 107 to provide local memory for the system's processing cores, a power supply to provide electrical power (not shown) and other supporting chips (also not shown).

Certain systems can also include a network interface controller (NIC) and/or infrastructure processing unit (IPU) 111 to provide network access for the system 110, whereas, other groups of systems can be coupled to a same NIC/IPU for network access. The NIC/IPUs 111 couple their respective systems to a network 112 that communicatively couples the systems to one another. The platform also includes mass storage systems with non volatile mass storage devices 113 such as solid state drives, hard disk drives, etc.

Notably, the platform 100 has different points of power consumption control (not shown) that are used to control the platform's power consumption. The points of power consumption control can be viewed as coarse grained or fine grained depending on the extent of the electronic circuitry whose power consumption is controlled from the point of control.

For example, in the case of coarse-grained control, an entire system 110 and/or group of systems can have a power control point that affects the power consumption of an entire system or group of systems (a group of systems can be, e.g., a set of rack mountable units that are plugged into a same rack). Examples include a controllable supply voltage source that provides an electrical supply voltage to an entire system or group of systems and/or a clock signal generation circuit whose clock signal is provided to multiple semiconductor chips within a system or group of systems, etc. Here, lowering the supply voltage and/or clock frequency at these single points of control will reduce the power consumption of an entire system and/or group of systems.

By contrast, in the case of fine-grained control, the power consumption of only a single component or small group of components are controlled from a single point of control. High performance semiconductor chips are often designed to include fine-grained power control for a chip's main components such as separate supply voltage configurability and/or individual clock signal frequency configurability for each of the chip's processing cores 102, memory controller 103, cache 104, I/O hub 105 and internal network 106. Connectivity can also have fine-grained power control such as the ability to set the power consumption and performance of a particular link between a chip and its memory, between a chip and another chip within a same chip package, between chip packages, etc.)

The network 112 can also have points of coarse-grained and fine-grained power consumption control such as a control point for controlling the power of a network switch system (coarse-grained) and a control point for controlling the physical layer hardware (e.g., ships, drivers, receivers, etc.) for a particular data link between two switch systems.

The platform 100 also has different points of cooling control (not shown in FIG. 1) that are used to control the different cooling systems that remove heat generated by the platform's semiconductor chips. The points of cooling control can also be viewed as coarse-grained or fine-grained depending on the extent of the electronic circuitry that is cooled from the point of control.

For example, in the case of coarse-grained control, an entire system and/or group of systems can have a cooling control point that affects the cooling of the entire system or group of systems. Examples include immersion cooling (in which an entire system or group of systems is/are submersed in dielectric liquid) having controllable heat removal capacity, fan cooling where the fan speed is controllable for a flow of air that is directed over the chips within a system or group of systems, and, liquid cooling where the temperature and/or fluid flow rate can be controlled for a chilled flow of liquid that runs through the respective cold plates that are coupled to chip packages within a same system or group of systems.

By contrast, in the case of fine-grained control, the cooling of a single component or small group of components is controlled from a single point of control. Examples include a fan whose speed is controllable and whose air flow primarily flows through a heat sink that is coupled to a single semiconductor chip package, liquid cooling where the temperature and/or fluid flow rate can be controlled for a chilled fluid flow that runs through the respective cold plate(s) of the respective packages for a few chips or only one chip within a single system, and, spray cooling where an ejected coolant spray is sprayed upon a single chip package and/or its heat sink.

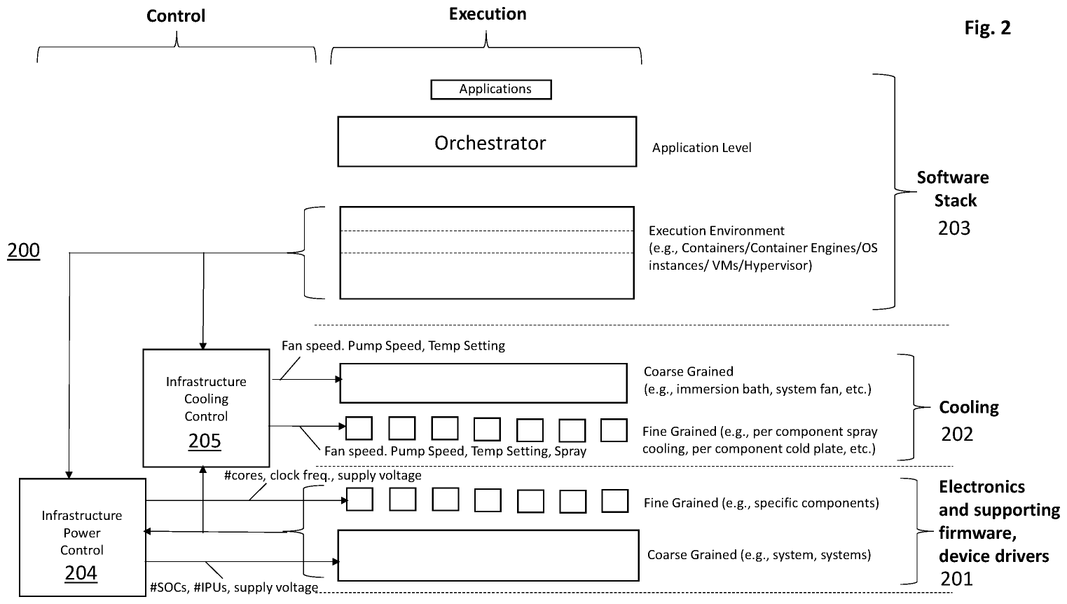

FIG. 2 depicts exemplary software and hardware for an information systems platform. The platform includes electronic hardware 201 and cooling systems 202, e.g., as described just above with respect to FIG. 1, where the power consumption of the electronic hardware and the cooling capability of the cooling systems are controlled at various control points including both fine grained points of control and coarse grained points of control.

Here, at least some of the high performance semiconductor chips are CPU chips that execute the applications and underlying software components 203. In various embodiments, the underlying software components upon which the applications execute include, from the “bottom-up”, firmware and device drivers that execute specific control functions for specific electronic hardware components. Above the firmware and device drivers are virtual machine monitors (VMMs), or hypervisors, that control the electronic hardware from a higher level than the firmware/device drivers, and, provides/instantiates multiple virtual machines (VMs) for higher layers of software.

Operating system (OS) instances typically execute on the VMs and application software programs execute on the OS instances. Alternatively or combined, container engines (e.g., Kubernetes container engines) respectively execute on the OS instances. The container engines provide virtualized OS instances and the containers execute on the virtualized OS instances. The containers can provide an isolated execution environment for a suite of applications which can include applications for micro-services. Various VMM supported execution environments also virtualize components (“IOV”) such as network controllers, network interfaces (e.g., a virtualized interface commonly referred to as “single root IOV” (SR-IOV) or scalable IOV (S-IOV)), storage controllers and/or storage interfaces.

Traditionally power consumption and cooling consumption control is implemented with “low level” control software 204, 205 that relies upon a coordinated effort of firmware, device drivers, the hypervisors and/or software processes (e.g., OS instance processes) that have special security permissions with the hypervisors/firmware/device drivers.

Here, a feedback loop exists where monitors that are embedded within the electronic hardware, the cooling systems, the hypervisors and/or high security OS processes feed telemetry information (e.g., chip temperatures, liquid coolant temperatures, supply voltage node current draws, clock frequency settings, enablement/disablement states of certain electronic components, input workload queue states, fan speeds, liquid coolant pump speeds, liquid coolant flow rates, etc.) to the low level control software 204, 205. The low-level control software 204, 205 processes the feedback information and attempts to set appropriate electrical power consumption and thermal cooling settings in response.

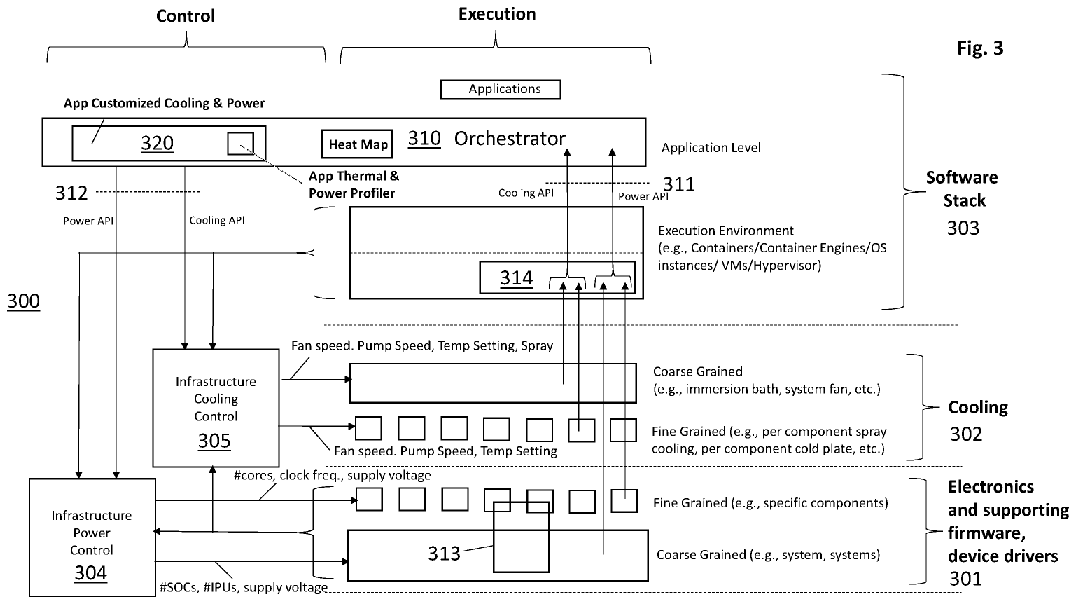

FIG. 3 depicts a software and hardware platform 300 with improved cooling. In the approach of FIG. 3, the telemetry information is exposed to higher levels of software, such as the application software level 303, where imminent but not yet in-flight software workloads are being orchestrated and/or determined (the application layer is typically above the OS or container engine in a software stack). The telemetry information is passed to the application layer 303 through one or more application programming interfaces (APIs) 311.

The current state of the platform (the telemetry) as received through the APIs 311, combined with the imminent workload demand as understood at the application software level 303, provides a better foundation for determining appropriate power consumption and/or thermal settings for the platform's future state. Such appropriate power consumption and/or thermal settings can then be put into effect pro-actively ahead of time (e.g., “predictive power consumption”, “predictive thermal generation”, and/or “predictive cooling”).

Here, with the improved platform 300 of FIG. 3, application software 303, such as an orchestrator 310, constructs/organizes the platform's future workloads while processing the platform's real time telemetry information as received through APIs 311 (an orchestrator allocates platform resources to support the execution of one or more applications). By combining the two perspectives (future workload and current platform power/thermal state), the orchestrator 310 is able to determine appropriate “suggested updates” to the platform's current power consumption and/or thermal settings.

The suggested updates are passed to the platform's low-level control software 304, 305 from the orchestrator 310 through control APIs 312. The low-level control software 304, 305 then considers the application software's suggested changes and applies those suggested updates that the low level control software 304, 305 deems to be acceptable/allowable. Notably, the suggested updates can be applied by the low level control software 304, 305 just before a workload that the orchestrator 310 was constructing when it generated the suggested updates is actually launched onto the platform 300 for execution.

This particular approach is particularly suitable for heterogeneous computing in which the workload of, e.g., a single application, incorporates the processing of different types of processing resources. By understanding which processing resources are going to be relied upon by a workload whose execution definition upon the platform is under construction, and by understanding the current power/thermal states of specific ones of these processing resources, the orchestrator 310 can, e.g., determine that the performance state of a particular processing resource should be increased and/or that the cooling apparatus for a particular processing resource should be stepped up to a larger heat removal capacity.

For example, if a particular workload that is under construction by the orchestrator 310 relies upon a CPU, a GPU and an accelerator, the orchestrator 310 will define the workload's execution on the platform 300 by selecting a particular CPU, a particular GPU and a particular accelerator to execute the workload.

By considering the current power/thermal state of the platform's CPU, GPU and accelerator resources, the orchestrator 310 can steer away from selecting any particular CPU/GPU/accelerator that is currently under heavy workload, and/or, once selections have been made for a particular CPU, GPU and accelerator, determine if the addition of the workload warrants increasing the performance state (increasing the number of enabled cores, supply voltage and/or clock frequency) of the selected CPU, selected GPU and/or selected accelerator, and/or, warrants increasing the heat removal capacity of the cooling apparatus for the selected CPU, the selected GPU, and/or, the selected accelerator.

In the case where increasing the performance state and/or increasing the heat removal capacity of the cooling apparatus for any of the selected CPU, the selected GPU, and/or, the selected accelerator is warranted, the orchestrator 310 informs the power/thermal control software through the control APIs 312 so that the changes can be effected on the platform 300 before the selected CPU, GPU and accelerator are used to execute their portion of the workload.

Notably, such changes can be effected concurrently (e.g., all at once or substantially simultaneously) before the workload is launched for execution, can be effected in stages before corresponding stages of the workload are executed (“pipeline”), etc. In the case of the later (pipeline), for example, if the workload entails the CPU executing first, then the GPU executing on the CPU output, then the accelerator executing on the GPU output—the CPU's power/thermal changes can be effected before the GPU's which can be effected before the accelerator's. Thus, in various embodiments, the orchestrator 310 not only informs the power/control software 304, 305 of which resources are to have their power/thermal settings changed and what the changes entail, but also, timing information (including relative timing amongst resources) of when such changes should be made.

It is pertinent to note that platform resources other than processors and processing cores can be implicated by the orchestrator's resource selection process. Moreover, such other resources can also have configurable performance states and a configurable cooling apparatus. For example, referring briefly back to FIG. 1, if an orchestrator selects one or more processing cores 102 from a particular high performance semiconductor chip 101 to support a particular workload, the selection could increase traffic across the chip' internal network 106, through the chip's memory controller 103 and to/from the chip's local memory 107.

As such, the orchestrator 310 can further suggest performance state changes for any of these components 102, 103, 106, 107 and consider whether the suggested performance state changes of these components also warrant changing the state of their respective cooling system(s) (e.g., if performance state increases are suggested for at least one processing core 102, the internal network 106 and the memory controller 103 of a same semiconductor chip 101, then, an increase in the heat removal capacity of the chip's cooling system could also be warranted (as well as an increase in the performance state and heat removal capacity of the local memory and the local memory's cooling apparatus (e.g., a fluidic cold plate that runs across the memory chips of a dual-in-line memory module)).

Implications for external components can also be considered by the orchestrator 310. For example, again referring briefly back to FIG. 1, if the orchestrator 310 selects processing resources on two separate semiconductor chips that are coupled through a portion of a network 112 that both chips are coupled to, the orchestrator 310 can consider increasing the performance state and/or heat removal capacity of the cooling apparatus for the platform resources associated with the network connectivity between the two chips (e.g., the chips' respective NICs/IPUs, switching systems, switching chips and/or data link chips within the portion of the network that information between the chips will be sent over, etc.).

The orchestrator 310 can also consider the performance and/or cooling of platform components that supply electrical power to the platform's semiconductor chips such as a power supply unit and one or more voltage regulators.

When considering performance and/or cooling system state changes, the orchestrator 310 can not only consider the resources used by a particular workload when constructing the workload's execution definition, but, also the resources used by other workloads whose execution definition is concurrently being constructed with the particular workload, and/or, that will execute concurrently on the platform 300 with the particular workload. Said another way, the orchestrator 310 can consider the future state of the platform 300 as a combination of the platform's current state and the set of workloads that are about to be launched on the platform 300.

As described above, lower level software that has visibility into the resources of the platform 300 provides one or more APIs 311 to the application layer 303 of software. The APIs 311 provide a set of functions that allow application level software, such as the orchestrator 310 to: 1) discover the platform's electronic hardware resources (fine grained and/or coarse grained); 2) discover the interconnectivity between the electronic resources (e.g., the connectivity between the cores, cache and memory controller on a same chip with the chip's internal network 106, connectivity of an external network 112, etc.); 3) discover the electronic resources' respective capabilities (e.g., power models that describe the respective resources' appropriate performance state as a function of workload and power consumption as a function of performance state and/or workload); 4) discover the electronic resources' current power consumption and/or performance state and/or thermal state; 5) discover the platform's thermal cooling resources (fine grained and/or coarse grained); 6) discover the thermal cooling resources' respective capabilities (e.g., heat removal capacity as a function of input power, heat removal capacity as a function of configurable input variable (e.g., fan speed, pump speed, flow rate, refrigeration temperature setting, etc.); 7) discover which electrical resources are cooled by which thermal cooling resources; 8) discover the thermal cooling resources' current state (e.g., current temperature, current heat removal capacity, etc.); 9) obtain models for the different respective cooling resources, etc.

The platform and software stack can include embedded functionality 313, 314 to help expose the platform details through APIs 311. For example, electronic functionality 313 can directly query a number of different electronic components and/or systems, and/or work with their device driver software, to collect and synthesize the monitoring of these electronic components/systems. The collected and synthesized data is then reported to higher level software 314 that collects similar data from other electronic systems/components to collect a wider scope of data across the platform and then synthesize, organize and/or coalesce the collected information for presentation to the application layer through APIs 311.

As described above, and as described in more detail at length below, an application software program, such as orchestrator 310, uses the APIs 311 to understand the platform's organization and current operational state. This information can then be processed along with the construction of the execution definitions for upcoming application workloads to see if any performance state and/or cooling apparatus state changes are appropriate. If such changes are appropriate, the suggested changes are presented to the lower level power/thermal control software through another one or more control APIs 312. Thus, the orchestrator 310 in various embodiments can receive current state information for the performance/power of various platform components, including the current state of the components' corresponding cooling systems, and effect change to the same (e.g., based on modeling and prediction of the components as described herein). The components can include any hardware on the platform including but not limited to CPUs, GPUs, accelerators, memory modules, network interfaces, components within a network, power supplies, voltage regulators, etc.

The one or more control APIs 312 provide functions that the orchestrator 310 can call to formally provide the suggested changes. Such functions can include a syntax for: 1) identifying an electrical resource to enabled or disabled (fine-grained or coarse grained); 2) identifying an electrical resource (fine grained and/or coarse grained) for a suggested change in performance state; 3) if 2) above applies, identifying the suggested change in performance state; 4) identifying a thermal cooling system to enabled or disabled (fine-grained or coarse grained); 5) identifying a thermal cooling system (fine grained and/or coarse grained) for a suggested change in operational state (e.g., change in fan speed, change in fluid flow rate, change in coolant fluid temperature, etc.); 6) if 5) above applies, identifying the suggested change in state for the identified cooling system.

The low-level control software 304, 305 scrutinizes the suggested changes provided by the orchestrator 310 against deeper, platform level policies, rules and/or requirements. For example, if the platform operator specifies that the total power consumption of the platform 300 or a particular coarse-grained resource or fine-grained resource is not to exceed some maximum allowed performance state or power consumption level, the low-level power control software 304 can reject a suggestion provided by the orchestrator 310 to increase the resource's performance state if implementation of the suggestion would violate the platform level policy/rule/requirement. The rejection can be fed back from the power control software 304 to the orchestrator 310 through the control API 312 so that the orchestrator 310 can consider changing the execution definition of one or more workloads that are under construction.

Similarly, if a platform level policy/rule/requirement specifies that the total heat removal capacity of the platform's cooling systems, a coarse-grained cooling system or fine-grained cooling system is not allowed to exceed some maximum allowed level (e.g., to keep the implicated cooling system(s) within a preferred operating range), the low-level thermal control software 305 can reject a suggestion provided by the orchestrator 310 to increase a cooling system's heat removal capacity if implementation of the suggestion would violate a platform level policy/rule/requirement. Again, the rejection can be fed back to the orchestrator 310 via the control APIs 312.

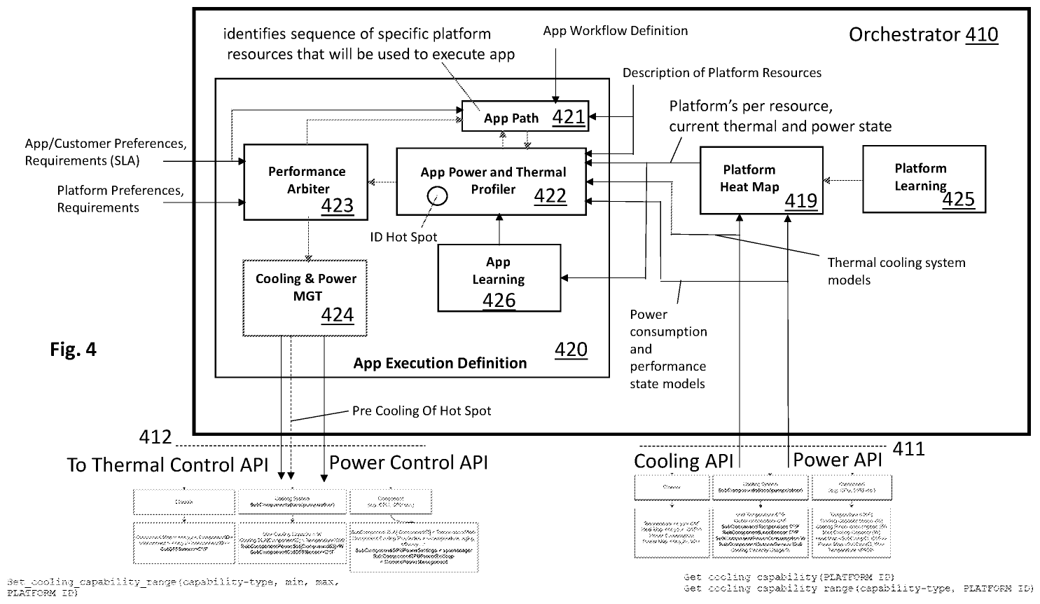

FIG. 4 shows an embodiment of an orchestrator 410 that uses APIs 411, 412 as described at length above to access information pertaining to the electrical power consumption and thermal cooling of a platform that executes the application software programs that the orchestrator 410 constructs execution definitions for. As discussed above, in many cases, the application software programs are heterogeneous workloads. A heterogeneous workload can invoke different types of processor resources (e.g., CPUs, GPUs, accelerators) over the course of its execution. For each processor type that is used by a workflow whose definition is under construction, the orchestrator 410 selects a particular processor from amongst a plurality of processors of the type.

By calling one or more functions through the APIs 411, the orchestrator 410 builds an understanding of the fine-grained and coarse-grained electrical resources (e.g., components and systems) of the platform, their current performance states and electrical power consumption, and, obtains respective models for the resources that describe a resource's electrical power consumption and functional performance/capability as a function of its performance state. The performance states can be defined as high level variables (e.g., P1, P2 etc.) and/or can articulate specific enabled/disabled components (e.g., processing cores), supply voltages and clock frequencies on a per component basis.

Likewise, by calling one or more functions through the APIs 411, the orchestrator builds an understanding of the fine-grained and coarse-grained cooling systems of the platform, their current heat removal capacity states and current electrical power consumption, and models that describe their heat removal capacity and electrical power consumption as a function of their performance state.

The orchestrator's understanding of the current, respective states of the platform's electrical components and thermal cooling systems corresponds to a “heat map” 419 from which over-utilized components and under-utilized components are readily identified. Notably, in other embodiments, the heat map 419 is generated by the functionality 314 that provides the APIs 311, 411 and the heat map 419 is provided to the orchestrator 410 through an API function call.

To determine a particular application's execution definition and any suggested changes to the platform's current state to prepare the platform for the application's execution, an application execution definition function 420 receives a description of the application's workload.

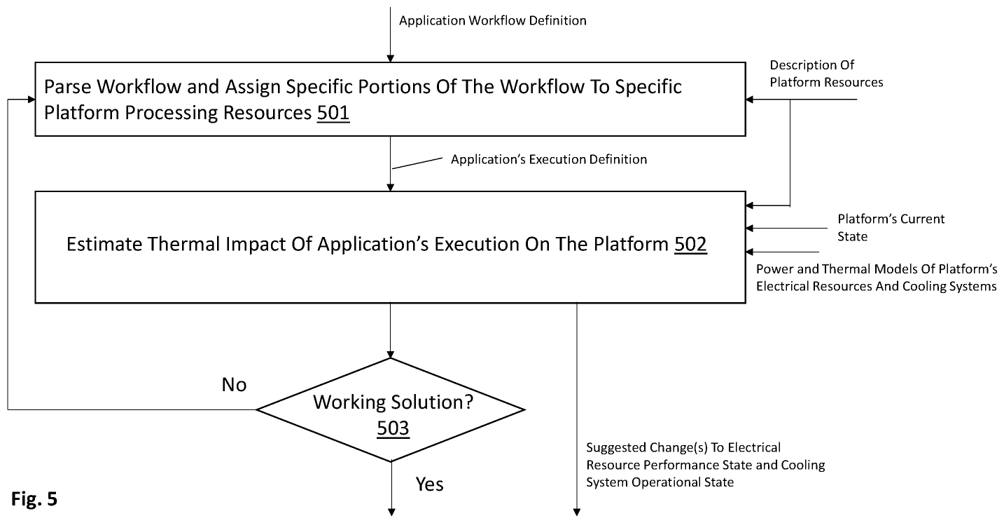

FIG. 5 elaborates on an embodiment of a methodology performed by the application execution definition function. Referring to FIGS. 4 and 5, from the workload description, the processing, memory and storage resources that are utilized by the application can be understood. The description of the application workload can also describe execution targets for the application such as performance targets (e.g., maximum time allowed to complete the application after the application begins, maximum electrical power needed to execute the application, etc.).

The application execution definition function 420 also receives information gathered from the APIs 411 such as: 1) a description of the hardware platform's electrical and thermal cooling system components; 2) their current state (heat map 419); 3) performance/power models for the electrical components and thermal cooling system components.

An application path definition function 421 processes the application description information and the platform electrical resource information, and then, selects specific platform resources to execute the application 501. In the case of a heterogenous application, for example, the application path definition function 421 will parse the workflow into different portions that use different processing resource types (CPU, GPU and accelerator), and then, assign a specific CPU to execute a first workload portion, assign a specific GPU to execute a second workload portion and assign a specific accelerator to execute a third workload portion. In other cases, a specific system is chosen to execute the application or portion of the application, where, which specific resources within the system that will be used to execute the application are determined, e.g., by lower layer software during or closer to application runtime.

An application power and thermal profiler function 422 then attempts to predict the impact that the execution of the application's workload on the platform will have in terms of power consumption and heat generation 502. In an embodiment, the application path function 421 and application power and thermal profile function 422 work together (e.g., iteratively 503) to select specific resources to support the application in view of various policies and/or resource selection algorithms.

For example, a first criteria can be to minimize the number of enabled components and maximize the number of disabled components (so doing could, e.g., help suppress overall platform power consumption). In this case, the path function 421 will attempt to execute as many applications as it can with as few resources as it can. So doing will drive up the power consumption of the enabled resources as applications are added to the platform for concurrent execution.

As such, if an enabled set of resources are chosen for execution of the application by the path function 421 (e.g., a particular currently enabled CPU core, a particular currently enabled GPU core, and, a particular currently enabled accelerator core), the power and thermal profiler 422 then executes the models of the selected resources to understand/estimate what the power consumption of these resources will be at the moment they are executing the application.

In various embodiments the model execution attempts to understand the total power consumption of these resources as they execute not only the particular application whose resources are currently being selected but also other (previously defined) applications that will be concurrently executing on these resources with the application.

In various embodiments, functionality 314 assists or even performs the power and thermal profiling instead of the orchestrator 320, 420. For example, if the models are considered to be highly sensitive or confidential, the orchestrator 410 can be provided with a high level description of the platform and the orchestrator defines a possible application path 421 for a particular application. The application path 421 is then provided to functionality 314 from the orchestrator 410 through the APIs 311, 411. Functionality 314 maintains the models and executes the power and thermal simulation and then returns the simulation results to the orchestrator 410 through the APIs 311, 411.

With respect to security, in various cases the orchestrator 410 is assigned a certain security permission level (privileged level) that functionality 314 maintains the role of. Thus, different orchestrators can have more or less visibility into the platform depending on their security clearance (more visibility corresponds to more available functions and/or detailed function call results through the APIs 311, 411). Functionality 314 assigns certain roles (each role corresponding to a different set of platform details that are exposed) to certain security levels. A particular orchestrator is given a particular security level which determines the orchestrator's visibility into the platform.

Returning to a discussion of the modeling, the selection of specific processing resources for a workload can implicate specific networking resources, such as a chip's internal network, and/or specific data links/paths within s chip's internal network. Likewise, a chip's external networks and/or links Implications can be implicated by the selection of certain processing resources. For example, if different selected processing resources for a same workload are located on different chips, the selection of the different processing resources can implicate chip-to-chip data links (e.g., within a same chip package and/or within a same system) and/or specific data links and/or switching systems within a multi-nodal hop network between the chips. Any/all of these network resources can have their current power and thermal state reflected in the heat map 419, and, models for these network resources can be included in the modeling performed by the profiler 422 to access the impact to the platform by the executing of the workload on the platform with the processing resources selected by the path definition function 421.

The modeling will indicate that a particular resource's performance state should be increased if the resource is to support the application in addition to (concurrently with) the other applications the resource has already been assigned to support execution of. Thus, a first suggested change in the platform's current state can be generated (increasing the performance state of the resource). In various embodiments, the higher performance state corresponds to over-clocking the resource (e.g., a clock with a frequency that is near or exceeds the maximum frequency specified for the resource).

If no higher performance state is available, the path function's 421 resource selection process can move on to another enabled resource and repeat the process. If none of the enabled resources have a higher available performance state, then the suggested platform could be to enable a particular resource that is currently disabled.

If the modeling determines that the performance state of a particular resource should be increased and the higher performance state is available, thermal modeling by the profiler 422 is executed to see if the current state of the thermal cooling system for the resource can withstand the additional heat generated by the resource after it is placed in the new, higher performance state.

If the thermal modeling indicates that the additional heat generated by the resource as a consequence of its being placed into the higher performance state causes the total heat that will need to be removed by the resource's thermal cooling system to increase to a level that is exceeds or is within some margin of the maximum heat removal capacity of the cooling system's current state (a “hot spot” is identified), another suggested platform change could be generated to increase the heat removal capacity of the resource's cooling system (e.g., spray cool the resource, increase a fan speed, increase a fluid flow rate, lower a temperature of a cooling fluid). In various embodiments, the higher performance state is an over-clocked component.

If the electrical power consumption modeling and resource selection process indicated that a currently disabled resource should be enabled, then, corresponding thermal modeling is performed. If the proposed newly enabled resource's thermal cooling system is already enabled (e.g., because it is coarse grained), then, like above, a suggested change to increase the cooling system's heat removal capacity could be generated if enablement of the new resource and its execution of the application would cause the thermal cooling system's heat removal capacity to be exceeded or approached. If the proposed newly enabled resource's thermal cooling system is not enabled, a suggested change to enable the cooling system could be generated if the enablement of the new resource and its execution of the application would generate enough heat to warrant enablement of the cooling system. Note that a resource can have more than one cooling system (e.g., a particular chip package can have both a fine grained cold plate and a coarse grained system fan).

The above described power and thermal modeling and analysis is performed, e.g., for each resource used by the application's workload until a set of resources have been settled upon to execute the application. Notably, the platform's expected performance of the application (end-to-end completion time) and the platform's expected power and thermal state that results from its execution of the application are also generated as part of the process, along with any of the suggested changes to the platform's current power and thermal state.

The expected performance of the application and expected platform power and thermal state can then be scrutinized by an arbiter 423 against service level agreements (SLA), service level objectives (SLO) and/or policies established by the customer (e.g., who provided the application) and the service provider (e.g., who owns and operates the platform). Here, for example, the expected performance of the application should be within a range specified by the customer and the platform's power and thermal state should be within a range deemed acceptable to the service provider. Either or both of the customer and provider can also specify other targets such as energy usage, emissions impact, etc.

If customer or service provider policies are offended or SLA/SLO terms are not met, the selection process is repeated with additional criteria such as to increase performance (if the customer policy was offended) or lower platform power consumption (if the service provider policy was offended).

If no policies are offended and/or the SLA/SLO terms are satisfied, the suggested changes are submitted to the low level control software 304, 305 through the control APIs 412 for implementation. As described above, the low level control software 304, 305 can also scrutinize the changes to see if they offend any platform and/or resource level policies. Alternatively, such policies could be provided to the arbiter through the control APIs 412 so that the low-level software 304, 305 does not have to scrutinize the changes.

If the low level control software 304, 305 does not object to the suggested changes, the low level control software 304, 305 makes the changes to the performance states of the affected resources and the operational states of the affected thermal cooling systems. Upon completion of the changes into the platform, the low-level software 304, 305 can confirm back to the orchestrator 410 that the changes have been made (e.g., via the control APIs 412). The orchestrator 410 can then cause the application to be launched on the platform for execution.

Notable, the orchestrator includes artificial intelligence learning and inference components 425, 426 that observe and learn power and thermal behaviors at both the platform 425 and application levels 426 (artificial intelligence uses a neural network where weights are assigned to synapses (connections) between nodes of different nodal layers within the neural network).

In the case of platform level 425 learning and execution, the artificial intelligence function can learn how certain platform power consumption states and thermal system operating states change into subsequent platform power consumption states and thermal system operating states.

For example, the platform level artificial intelligence 425 can learn that a certain combination of specific applications and their corresponding workloads when assigned to execute on a specific combination of resources caused the power consumption of the platform to change in a specific way (increase by at least a certain amount or decreased by at least a certain amount) and learn how the thermal cooling systems were adjusted to handle the change in power consumption. The learning can then be applied to improve the accuracy of the models that are provided to the application execution definition engine 420. The improved models can be per resource/component models or platform level models.

In various embodiments the platform level artificial intelligence 425 can also directly drive suggested performance state and cooling system operating state changes through the control APIs, e.g., irrespective of any new workload whose execution definition is under construction. For example, after learning that a certain combination of specific applications and their corresponding workloads, when assigned to execute on a specific combination of resources, caused the power consumption of the platform to change in a specific way, the platform artificial intelligence 425 can recognize that the orchestrator 410 is about to launch a same/similar combination of workloads and resources and suggest the learned changes to the low-level control software 304, 305 through APIs 312, 412 as a pro-active attempt to place the platform in a more appropriate state.

The application artificial intelligence 426, by contrast, observes and learns the platform's behavior in response to executing a specific application specifically. Here, the application artificial intelligence can invoke functions through the cooling and power APIs 311, 411 to observe how the platform and/or the specifics resources used to support the application behaved when the application was executing. The application artificial intelligence 426 can then use this information to tweak and/or improve the models used by the power and thermal profiler 422.

Both the platform and application artificial intelligence functions 425, 426 can observe and learn certain external variables that affect platform and/or application behavior such as platform/application fluctuations over the course of a 24 hour period, as a function of weather conditions (e.g., extremely hot or cold days can affect thermal cooling system performance), as a function of seasonal conditions, etc. The accuracy of the models used for the platform and/or specific resources can then be improved with this learned intelligence.

Note that FIG. 4 provides some exemplary data structures and commands for both the cooling and electrical power APIs 411 and the control APIs 412. The Appendix provides an exemplary API specification for the cooling and electrical power APIs 411 (sections 1 and 2 of the Appendix) and the control APIs (sections 3 and 4 of the Appendix). Here, application software, such as an orchestrator, calls a function (col. 1 in the Appendix) through the API and includes the function's associated operand (col. 2 in the Appendix). The API returns the corresponding information (col. 3 in the Appendix). In various embodiments, the application software can receive push notifications through the API from the lower platform software (e.g., telemetry information that is provided regularly at some specific frequency and/or is event driven).

Although embodiments above have stressed the use of an orchestrator 320, 420 to implement the improvements described at length above, other forms of software can incorporate the teachings above. For example, an application can include its own execution definition functionality 420 rather than use APIs to, e.g., generate or receive a platform heat map, etc. One or more deeper software layers within the software stack can also incorporate the predictive modeling, predictive performance state settings and/or predictive cooling system settings taught above such as a hypervisor, a container manager; and/or an operating system. Firmware such as Basic Input/Output System (BIOS) firmware, Unified Extensible Firmware Interface (UEFI) firmware, and/or the Intelligent Platform Management Interface (IPMI) firmware can at least include predictive thermal setting functionality as described at length herein.

Although embodiments above have stressed that performance state settings of platform electrical components and/or platform cooling systems are put in place “before” an application begins execution, in various embodiments, such settings can also be applied during application execution (after the application has begun execution).

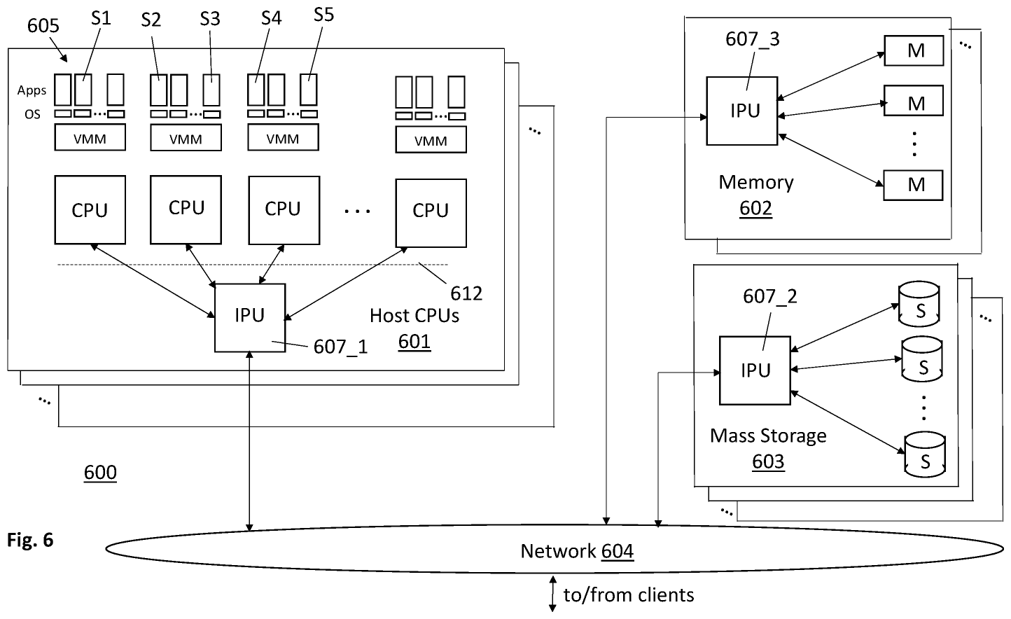

FIG. 6 shows a new, emerging data center environment in which “infrastructure” tasks are offloaded from traditional general purpose “host” CPUs (where application software programs are executed) to an infrastructure processing unit (IPU), edge processing unit (EPU), or data processing unit (DPU) any/all of which are hereafter referred to as an IPU.

Here, the aforementioned CSP primary resources and/or the aforementioned remote CSP resources located at customer locations can be implemented with one or more data centers including one or more data centers that embraces the emerging data center environment of FIG. 6.

Networked based computer services, such as those provided by cloud services and/or large enterprise data centers, commonly execute application software programs for remote clients. Here, the application software programs typically execute a specific (e.g., “business”) end-function (e.g., customer servicing, purchasing, supply-chain management, email, etc.). Remote clients invoke/use these applications through temporary network sessions/connections that are established by the data center between the clients and the applications. A recent trend is to strip down the functionality of at least some of the applications into more finer grained, atomic functions (“micro-services”) that are called by client programs as needed. Micro-services typically strive to charge the client/customers based on their actual usage (function call invocations) of a micro-service application.

In order to support the network sessions and/or the applications' functionality, however, certain underlying computationally intensive and/or trafficking intensive functions (“infrastructure” functions) are performed.

Examples of infrastructure functions include routing layer functions (e.g., IP routing), transport layer protocol functions (e.g., TCP), encryption/decryption for secure network connections, compression/decompression for smaller footprint data storage and/or network communications, virtual networking between clients and applications and/or between applications, packet processing, ingress/egress queuing of the networking traffic between clients and applications and/or between applications, ingress/egress queueing of the command/response traffic between the applications and mass storage devices, error checking (including checksum calculations to ensure data integrity), distributed computing remote memory access functions, etc.

Traditionally, these infrastructure functions have been performed by the CPU units “beneath” their end-function applications. However, the intensity of the infrastructure functions has begun to affect the ability of the CPUs to perform their end-function applications in a timely manner relative to the expectations of the clients, and/or, perform their end-functions in a power efficient manner relative to the expectations of data center operators.

As such, as observed in FIG. 6, the infrastructure functions are being migrated to an infrastructure processing unit (IPU) 607. FIG. 6 depicts an exemplary data center environment 600 that integrates IPUs 607 to offload infrastructure functions from the host CPUs 601 as described above.

As observed in FIG. 6, the exemplary data center environment 600 includes pools 601 of CPU units that execute the end-function application software programs 605 that are typically invoked by remotely calling clients. The data center also includes separate memory pools 602 and mass storage pools 603 to assist the executing applications. The CPU, memory storage and mass storage pools 601, 602, 603 are respectively coupled by one or more networks 604.

Notably, each pool 601, 602, 603 has an IPU 607_1, 607_2, 607_3 on its front end or network side. Here, each IPU 607 performs pre-configured infrastructure functions on the inbound (request) packets it receives from the network 604 before delivering the requests to its respective pool's end function (e.g., executing application software in the case of the CPU pool 601, memory in the case of memory pool 602 and storage in the case of mass storage pool 603).

As the end functions send certain communications into the network 604, the IPU 607 performs pre-configured infrastructure functions on the outbound communications before transmitting them into the network 604. The communication 612 between the IPU 607_1 and the CPUs in the CPU pool 601 can transpire through a network (e.g., a multi-nodal hop Ethernet network) and/or more direct channels (e.g., point-to-point links) such as Compute Express Link (CXL), Advanced Extensible Interface (AXI), Open Coherent Accelerator Processor Interface (OpenCAPI), Gen-Z, etc.

Depending on implementation, one or more CPU pools 601, memory pools 602, mass storage pools 603 and network 604 can exist within a single chassis, e.g., as a traditional rack mounted computing system (e.g., server computer). In a disaggregated computing system implementation, one or more CPU pools 601, memory pools 602, and mass storage pools 603 are separate rack mountable units (e.g., rack mountable CPU units, rack mountable memory units (M), rack mountable mass storage units (S).

In various embodiments, the software platform on which the applications 605 are executed include a virtual machine monitor (VMM), or hypervisor, that instantiates multiple virtual machines (VMs). Operating system (OS) instances respectively execute on the VMs and the applications execute on the OS instances. Alternatively or combined, container engines (e.g., Kubernetes container engines) respectively execute on the OS instances. The container engines provide virtualized OS instances and containers respectively execute on the virtualized OS instances. The containers provide isolated execution environment for a suite of applications which can include applications for micro-services. Various VMM supported execution environments also virtualize components (“IOV”) such as network controllers, network interfaces (e.g., a virtualized interface commonly referred to as “single root IOV” (SR-IOV) or scalable IOV (S-IOV)), storage controllers and/or storage interfaces.

Notably, the IPUs 607 can be useful supporting the improved power and thermal controlled data center described at length above with respect to FIGS. 3, 4 and 5 above. In particular, IPUs 607 can be used to implement (in hardware, software or combination of hardware and software) the lower level supporting functions 313, 314 described above. For example, the IPU for a specific pool can provide at least functions 313 for the specific pool. Functionality 314 can likewise be distributed across IPUs for specific to collect information for the pools, whereas, the APIs 311, 312 can be provided by IPUs that belong to a CPU pool that includes orchestrators and/or executes applications.

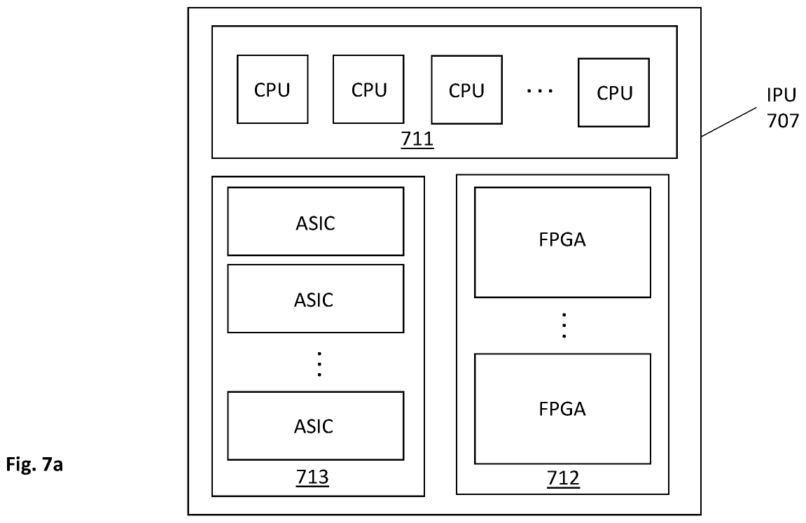

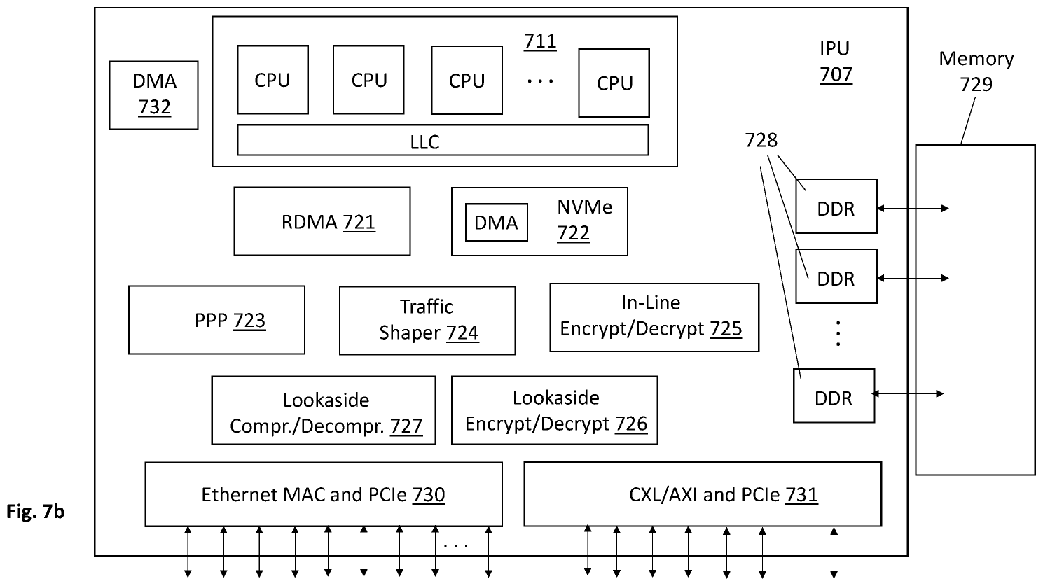

FIG. 7a shows an exemplary IPU 707. As observed in FIG. 7 the IPU 707 includes a plurality of general purpose processing cores 711, one or more field programmable gate arrays (FPGAs) 712, and/or, one or more acceleration hardware (ASIC) blocks 713. An IPU typically has at least one associated machine readable medium to store software that is to execute on the processing cores 711 and firmware to program the FPGAs (if present) so that the processing cores 711 and FPGAs 712 (if present) can perform their intended functions.

The IPU 707 can be implemented with: 1) e.g., a single silicon chip that integrates any/all of cores 711, FPGAs 712, ASIC blocks 713 on the same chip; 2) a single silicon chip package that integrates any/all of cores 711, FPGAs 712, ASIC blocks 713 on more than chip within the chip package; and/or, 3) e.g., a rack mountable system having multiple semiconductor chip packages mounted on a printed circuit board (PCB) where any/all of cores 711, FPGAs 712, ASIC blocks 713 are integrated on the respective semiconductor chips within the multiple chip packages.

The processing cores 711, FPGAs 712 and ASIC blocks 713 represent different tradeoffs between versatility/programmability, computational performance, and power consumption. Generally, a task can be performed faster in an ASIC block and with minimal power consumption, however, an ASIC block is a fixed function unit that can only perform the functions its electronic circuitry has been specifically designed to perform.

The general purpose processing cores 711, by contrast, will perform their tasks slower and with more power consumption but can be programmed to perform a wide variety of different functions (via the execution of software programs). Here, the general purpose processing cores can be complex instruction set (CISC) or reduced instruction set (RISC) CPUs or a combination of CISC and RISC processors.

The FPGA(s) 712 provide for more programming capability than an ASIC block but less programming capability than the general purpose cores 711, while, at the same time, providing for more processing performance capability than the general purpose cores 711 but less than processing performing capability than an ASIC block.

FIG. 7b shows a more specific embodiment of an IPU 707. The particular IPU 707 of FIG. 7b does not include any FPGA blocks. As observed in FIG. 7b the IPU 707 includes a plurality of general purpose cores 711 and a last level caching layer for the general purpose cores 711. The IPU 707 also includes a number of hardware ASIC acceleration blocks including: 1) an RDMA acceleration ASIC block 721 that performs RDMA protocol operations in hardware; 2) an NVMe acceleration ASIC block 722 that performs NVMe protocol operations in hardware; 3) a packet processing pipeline ASIC block 723 that parses ingress packet header content, e.g., to assign flows to the ingress packets, perform network address translation, etc.; 4) a traffic shaper 724 to assign ingress packets to appropriate queues for subsequent processing by the IPU 707; 5) an in-line cryptographic ASIC block 725 that performs decryption on ingress packets and encryption on egress packets; 6) a lookaside cryptographic ASIC block 726 that performs encryption/decryption on blocks of data, e.g., as requested by a host CPU 301; 7) a lookaside compression ASIC block 727 that performs compression/decompression on blocks of data, e.g., as requested by a host CPU 601; 8) checksum/cyclic-redundancy-check (CRC) calculations (e.g., for NVMe/TCP data digests and/or NVMe DIF/DIX data integrity); 9) thread local storage (TLS) processes; etc.

So constructed/configured, the IPU can be used to perform routing functions between endpoints within a same pool (e.g., between different host CPUs within CPU pool 601) and/or routing within the network 604. In the case of the latter, the boundary between the network 604 and the IPU's pool can reside within the IPU, and/or, the IPU is deemed a gateway edge of the network 604.

The IPU 707 also includes multiple memory channel interfaces 728 to couple to external memory 729 that is used to store instructions for the general purpose cores 711 and input/output data for the IPU cores 711 and each of the ASIC blocks 721-726. The IPU includes multiple PCIe physical interfaces and an Ethernet Media Access Control block 730, and/or more direct channel interfaces (e.g., CXL and or AXI over PCIe) 731, to support communication to/from the IPU 707. The IPU 707 also includes a DMA ASIC block 732 to effect direct memory access transfers with, e.g., a memory pool 602, local memory of the host CPUs in a CPU pool 601, etc. As mentioned above, the IPU 707 can be a semiconductor chip, a plurality of semiconductor chips integrated within a same chip package, a plurality of semiconductor chips integrated in multiple chip packages integrated on a same module or card, etc.

Embodiments of the invention may include various processes as set forth above. The processes may be embodied in program code (e.g., machine-executable instructions). The program code, when processed, causes a general-purpose or special-purpose processor to perform the program code's processes. Alternatively, these processes may be performed by specific/custom hardware components that contain hard wired interconnected logic circuitry (e.g., application specific integrated circuit (ASIC) logic circuitry) or programmable logic circuitry (e.g., field programmable gate array (FPGA) logic circuitry, programmable logic device (PLD) logic circuitry) for performing the processes, or by any combination of program code and logic circuitry.

Elements of the present invention may also be provided as a machine-readable storage medium for storing the program code. The machine-readable medium can include, but is not limited to, floppy diskettes, optical disks, CD-ROMs, and magneto-optical disks, FLASH memory, ROMs, RAMs, EPROMs, EEPROMs, magnetic or optical cards or other type of media/machine-readable medium suitable for storing electronic instructions.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

Some possible embodiments include the following examples.
Example 1. A method including receiving information associated with a software application's workflow. The method includes receiving information that describes a platform's current power consumption state and current thermal state. The method includes selecting platform components to support execution of the workflow. The method includes, prior to execution of the workflow upon the selected platform components, estimating a thermal impact to the platform's current thermal state as a consequence of the workflow's execution upon the selected platform components. The method includes determining a change to be made to a thermal cooling system of the platform in response to the estimating and causing the change to be made to the thermal cooling system prior to execution of at least a portion of the workflow on the platform.
Example 2. Example 1 above where wherein the method is performed by: an orchestrator; a hypervisor; a container manager; and/or an operating system.
Example 3. Examples 1 or 2 above wherein the estimating includes using models for the selected platform components and/or one or more systems that include the selected platform components, wherein, the models predict heat generated by the selected platform components during the workflow's execution upon the selected platform components.
Example 4. Examples 1, 2 or 3 above where the method includes executing an artificial intelligence function to predict a future power consumption state of the platform and a future thermal state of the platform.
Example 5. Examples 1, 2, 3 or 4 above where the method includes using an artificial intelligence function to learn from the platform's response to the execution of the workflow and predict the platform's response to a subsequent execution of the workload on the platform.
Example 6. Examples 1, 2, 3, 4 or 5 above where the method includes generating a new performance state for at least one of the selected platform components, and wherein, the estimating includes modeling operation of the at least one of the selected platform components within the new performance state.
Example 7. Example 6 above where the method includes confirming that the new performance state does not offend a first defined policy for the application and a second defined policy for the platform.
Example 8. A method that includes receiving from an application through an API data associated with a software application's workflow. The method includes generating a metric of a platform's current power consumption state and current thermal state. The method includes estimating a thermal impact to the platform's current thermal state as a consequence of the workflow's execution upon the selected platform components. The method includes sending a result of the estimating to the application through the API.
Example 9. Example 8 above where the application is an orchestrator.
Example 10. Examples 8 or 9 above wherein the estimating includes using models for the selected platform components and/or one or more systems that include the selected platform components, wherein, the models predict heat generated by the selected platform components during the workflow's execution upon the selected platform components.
Example 11. Examples 8, 9 or 10 above where the method is performed by an operating system and/or virtual machine monitor.
Example 12. Examples 8, 9 or 10 above where the method is performed by a platform software stack that includes a virtual machine monitor, a virtual machine and an operating system instance.
Example 13. A data center having a platform. The platform has a network, a plurality of CPUs coupled to the network, a plurality of GPUs coupled to the network and a plurality of accelerators coupled to the network. The data center has a machine readable storage medium containing program code that when processed by at least one of the plurality of CPUs causes the method of Example 1, 2, 3, 4, 5, 6, 7, 8, 9, 10, 11, 12 or 13 above to be performed.

### APPENDIX

1. Cooling API

| FUNCTION | OPERAND | RETURN |
|---|---|---|
| get_cooling_capability | Platform_ID | List of cooling systems on the |
| | | platform with the specified |
| | | Platform_ID . . . Different cooling |
| | | systems are specified with a |
| | | specific Cooling_System_ID) |
| get_cooling_capability_type | Type of cooling system (e.g., | List of cooling systems of the |
| | immersion, liquid cold plate, fan, | specified type on the platform with |
| | spray, etc.); Platform_ID | the specified platform ID . . . Different |
| | | cooling systems are specified with |
| | | a specific Cooling_System_ID) |
| get_cooling_capability | Cooling_System_ID | Cooling_Capability_Type(s). |
| | | Characterization of the cooling |
| | | capabilities of the cooling system |
| | | having the specified |
| | | Cooling_System_ID . . . Exemplary |
| | | Cooling_Capability_Type(s) include: |
| | | 1) heat removal ability (e.g., |
| | | amount of heat and/or energy |
| | | removed per unit time); 2) |
| | | temperature (e.g., of a cold plate, |
| | | of a coolant liquid); 3) fluid flow |
| | | (e.g., of a coolant liquid); 4) air flow |
| | | in the case of a fan, etc. |
| get_cooling_capability_range | Cooling_System_ID; | Range of the specified |
| | Cooling_Capability_Type | Cooling_Capability_Type for the |
| | | cooling system having the specified |
| | | Cooling_System_ID (e.g., min-max |
| | | range of heat removal |
| | | configurations; min-max range of |
| | | configurable temperature settings; |
| | | min-max range of configurable fan |
| | | speeds |
| get_cooling_model | Cooling_System_ID | Address where a heat removal |
| | | simulation model can be found for |
| | | the cooling system having the |
| | | specified Cooling_System_ID |
| get_current_state | Platform_ID | Current state of the set of cooling |
| | | systems on the platform with the |
| | | specified Platform_ID . . . Different |
| | | cooling systems are specified with |
| | | their respective |
| | | Cooling_System_ID . . . Current state |
| | | can include current configuration |
| | | settings and monitoring/telemetry |
| | | information such as fluid |
| | | temperature, ambient |
| | | temperature, etc. |
| get_cooled_component | Cooling_System_ID | List of electrical components that |
| | | are cooled by the cooling system |
| | | identified by the specified |
| | | Cooling_System_ID |

2. Electrical Component API

| FUNCTION | OPERAND | RETURN |
|---|---|---|
| get_platform_capability | Platform_ID | List of electrical components on |
| | | the platform with the specified |
| | | Platform_ID . . . Different electrical |
| | | systems are specified with a |
| | | specific Electrical_Component_ID) |
| get_component_subcomponent | Component_ID or SubComponent | List of subcomponents that are |
| | ID | integrated on the component |
| | | identified by the Component_ID. |
| | | Examples include different |
| | | functional blocks within a larger |
| | | component such as the different |
| | | processing cores within a multi- |
| | | core processor; the different |
| | | interfaces of and/or nodes within a |
| | | network; the different memory |
| | | modules of a main memory;, etc. |
| | | Different subcomponents are |
| | | identified with different |
| | | SubComponent_ID. |
| | | When input operand is of type |
| | | SubComponent, the function |
| | | returns the deeper subcomponents |
| | | of the Subcomponent identified in |
| | | the operand. |
| get_platform_interconnections | Platform_ID or Component ID | List of networks or other |
| | | communication channels between |
| | | components on the platform |
| | | specified by the Platform_ID, or, |
| | | subcomponents on the component |
| | | specified by the Component_ID. |
| | | Different networks/channels are |
| | | specified with different Nwk_ID. |
| | | Each Nwd_ID has associated list of |
| | | Electrical_Component_IDs or |
| | | SubComponent_IDs that identify |
| | | the different electrical components |
| | | or subcomponents on the platform |
| | | or component that can |
| | | communicate over the Nwk_ID. |
| get_power&performance_capability | Component_ID or | Power&Performance_Type(s). |
| | SubComponent_ID | Characterization of the |
| | | performance capabilities and/or |
| | | corresponding power consumption |
| | | capabilities of the component/sub- |
| | | component having the specified |
| | | Component_ID/SubComponent_ID. |
| | | Power&Performance_Type(s) |
| | | examples include: 1) list of |
| | | performance states and their |
| | | functional characteristics (e.g., P1 = |
| | | X Mb/s; P2 = Y MB/s, etc.); 2) |
| | | associated power consumption for |
| | | each of 1) above; 3) associated |
| | | heat generation for each of 1) |
| | | above;, etc. |
| get_performance&power_model | Component_ID or | Address where a simulation model |
| | SubComponent_ID | can be found for the component or |
| | | subcomponent having the specified |
| | | Component_ID or |
| | | SubComponent_ID. The simulation |
| | | can simulate, e.g., heat generation |
| | | as a function of performance state |
| | | for the specified component or |
| | | subcomponent. |
| get_current_state | Component_ID or | Current performance state of the |
| | SubComponent_ID | component identified by the |
| | | Component ID and/or the current |
| | | performance state of its |
| | | subcomponents, or, current |
| | | performance state of the |
| | | subcomponent identified by the |
| | | SubComponentID |
| | | Current performance state can |
| | | include current configuration |
| | | settings and monitoring/telemetry |
| | | information, etc. |
| get_cooling_system | Component_ID or | List of cooling system that cool the |
| | SubComponent_ID | identified component or |
| | | subcomponent. |

3. Cooling Control API

| FUNCTION | OPERAND | RETURN |
|---|---|---|
| set_cooling_capability_type | Cooling_System_ID; | Configures the cooling system |
| | Cooling_Capability_Type; | identified by the |
| | VALUE | Cooling_System_ID. The |
| | | parameter being configured is |
| | | identified by |
| | | Cooling_Capability_Type and the |
| | | configuration value to be |
| | | programmed for the parameter is |
| | | identified by VALUE. |

4. Electrical Control API

| FUNCTION | OPERAND | RETURN |
|---|---|---|
| set_power&performance_capability | Component_ID or | Configures the electrical |
| | SubComponent_ID; | component or subcomponent |
| | Power&Performance_Type; | identified by the Component_ID or |
| | VALUE | SubComponent_ID. The parameter |
| | | being configured is identified by |
| | | Power&Performance_Type and |
| | | the configuration value to be |
| | | programmed for the parameter is |
| | | identified by VALUE. |

1. A method, comprising:
receiving information associated with a software application's workflow;
receiving information that describes a platform's current power consumption state and current thermal state;
selecting platform components to support execution of the workflow;
prior to execution of the workflow upon the selected platform components, estimating a thermal impact to the platform's current thermal state as a consequence of the workflow's execution upon the selected platform components; and,
determining a change to be made to a thermal cooling system of the platform in response to the estimating and causing the change to be made to the thermal cooling system prior to execution of at least a portion of the workflow on the platform.

2. The method of claim 1 wherein the method is performed by:
an orchestrator;
a hypervisor;
a container manager; and/or
an operating system.

3. The method of claim 1 wherein the estimating comprises using models for the selected platform components and/or one or more systems that include the selected platform components, wherein, the models predict heat generated by the selected platform components during the workflow's execution upon the selected platform components.

4. The method of claim 1 further comprising executing an artificial intelligence function to predict a future power consumption state of the platform and a future thermal state of the platform.

5. The method of claim 1 further comprising using an artificial intelligence function to learn from the platform's response to the execution of the workflow and predict the platform's response to a subsequent execution of the workload on the platform.

6. The method of claim 1 further comprising generating a new performance state for at least one of the selected platform components, and wherein, the estimating comprises modeling operation of the at least one of the selected platform components within the new performance state.

7. The method of claim 6 further comprising confirming that the new performance state does not offend a first defined policy for the application and a second defined policy for the platform.

8. A method, comprising:
receiving from an application through an API data associated with a software application's workflow;
generating a metric of a platform's current power consumption state and current thermal state; and,
estimating a thermal impact to the platform's current thermal state as a consequence of the workflow's execution upon the selected platform components; and,
sending a result of the estimating to the application through the API.

9. The method of claim 8 wherein the application is an orchestrator.

10. The method of claim 8 wherein the estimating comprises using models for the selected platform components and/or one or more systems that include the selected platform components, wherein, the models predict heat generated by the selected platform components during the workflow's execution upon the selected platform components.

11. The method of claim 8 wherein the method is performed by an operating system and/or virtual machine monitor.

12. The method of claim 8 wherein the method is performed by a platform software stack comprising a virtual machine monitor, a virtual machine and an operating system instance.

13. A data center, comprising:
a platform comprising a network, a plurality of CPUs coupled to the network, a plurality of GPUs coupled to the network and a plurality of accelerators coupled to the network; and,
a machine readable storage medium containing program code that when processed by at least one of the plurality of CPUs causes a method to be performed, the method comprising:
receiving a description of a software application's workflow;
receiving information that describes a platform's current power consumption state and current thermal state;
selecting platform components to support execution of the workflow, the selected platform components comprising at least one CPU selected from the plurality of CPUs, at least one GPU selected from the plurality of GPUs and at least one accelerator selected from the plurality of accelerators;
prior to execution of the workflow, estimating a thermal impact to the platform's current thermal state as a consequence of the workflow's execution upon the selected platform components; and,
determining a change to be made to a thermal cooling system of the platform in response to the estimating and causing the change to be made to the thermal cooling system prior to execution of at least a portion of the workflow on the platform.

14. The data center of claim 13 wherein the method is performed by an orchestrator.

15. The data center of claim 13 wherein the estimating comprises using models for the selected platform components and/or one or more systems that include the selected platform components, wherein, the models predict heat generated by the selected platform components during the workflow's execution upon the selected platform components.

16. The data center of claim 13 wherein the method further comprises executing an artificial intelligence function to predict a future power consumption state of the platform and a future thermal state of the platform.

17. The data center of claim 13 wherein the method further comprises using an artificial intelligence function to learn from the platform's response to the execution of the workflow and predict the platform's response to a subsequent execution of the workload on the platform.

18. The data center of claim 13 wherein the method comprises generating a new performance state for at least one of the selected platform components, and wherein, the estimating comprises modeling operation of the at least one of the selected platform components within the new performance state.

19. The data center of claim 18 wherein the method further comprises confirming that the new performance state does not offend a first defined policy for the application and a second defined policy for the platform.

20. The data center of claim 19 wherein the first defined policy comprises a maximum total time of execution for the application and the second defined policy comprises a maximum power consumption for at least one of the selected platform components.
